(19) United States
(12) Patent Application Publication
(10) Pub. No.: US 2020/0234603 A1
(43) Pub. Date: Jul. 23, 2020

(54) SELF-SERVING WEBSITE FOR TUTORING BY STUDENT

(71) Applicant: FENGYING SU, weihai (CN)

(72) Inventor: FENGYING SU, weihai (CN)

(21) Appl. No.: 16/840,486

(22) Filed: Apr. 6, 2020

(51) Int. Cl. G09B 5/02; G06F 16/95; G06Q 20/14

(52) U.S. Cl. CPC G09B 5/02; G06Q 20/145; G06F 16/95

(57) ABSTRACT

A self-serving website is mainly for college or graduate students to tutor middle or high school or college students one on one online. No school or company is involved in organizing or participating registration and tutoring.

A person who wants to be a tutor can register on the website with a tutor APP down loaded, by filling in real name, school, major and grade, and uploading academic documents to be searched and viewed by learners. Each tutor sets up own tutoring fee per unit time. The website will record tutoring time, and make payment from learner's account to tutor's account when tutoring is over.

Tutoring on the website is very convenient with low fee.

### TECHNICAL FIELD

This invention is in the field of e-commerce, is about an online tutoring website.

### BACKGROUND

Online tutoring has advantages over tutoring in classroom: it can save time and space, teacher and students do not need to go to classroom for class.

But current online tutoring has disadvantages:

1. Cost is still high to run online school and to hire professional teachers.

2. Lack of one on one tutoring due to high cost. A class with many students often results in lower quality than one on one tutoring.

### SUMMARY

According to the present invention, a self-serving website is mainly for college or graduate students or graduates to tutor middle or high school or college students one on one online. No school or company is involved in registration and tutoring.

A person who wants to be a tutor can register on the website with a tutor APP down loaded, by filling in real name, school, major and grade, and uploading student ID, school record and GPA to be searched and viewed by learners. Each tutor sets up own tutoring fee per unit time. The website will record tutoring time, and make payment from learner's account to tutor's account when tutoring is over.

### DETAILED DESCRIPTION

A tutor or a learner can use a cell phone down load a tutor APP from a tutor website or APP application store. And then opens the APP and registers with a cell phone number or an email address.

A college or graduate student who wants to be a tutor can register on the website in tutor column, fill in real name, school, major, grade; upload student ID, school record and GPA. Self-picture, driver license and photo ID can also be uploaded to attract learners. Graduates wanted to register as tutors will need to upload certificate of graduation and diploma. Teachers wanted to register as tutors will need to upload teacher certificate.

A tutor can sets up own tutoring fee per unit time on the tutor's account for learners to pay.

A learner can register on the website in learner column, and deposit tutor fee on the learner's account. And then get into search page to search and select tutors according to tutor's school, major, grade, GPA, total tutoring time, per cent of trainees' satisfaction and tutoring fee required.

There is a search box and a search setting column in the search page to define a search. In the search box, tutor's information such as name of school and major, grade and GPA can be filled, and then click search icon to start search.

There are several boxes in the search setting column such as tutoring subject, tutor's school, major, GPA. When click the box of tutoring subject, several sub-boxes containing different subjects will appear, such as math, physics, chemistry and so on. A learner can select one of them by clicking it. When click the GPA box, three sub-boxes containing high, medium, low respectively will appear, and can select one of them. After some or all of the boxes in the setting column are selected with or without filling the search box, click the search icon to start a search.

After a search, tutor names who meet the search criteria will be listed on the website. In the listing, tutor names will be ranked by the facts of whether a tutor is online and ready for tutoring, whether academic documents are certified, GPA is high or low, total tutoring time is long or short, and per cent of learners' satisfaction is high or low. These information will be displayed next to each tutor name. And tutoring fee required will also be displayed next to tutor name.

Tutors who are logged in and ready for tutoring will be listed ahead of those who are not logged in. That is the first priority for listing.

Tutors whose academic documents are checked and certified by the website administrator will be listed ahead of those not certified. That is the second priority for listing. Tutors can pay to the website to get their academic document certified.

A tutor has higher GPA will be listed ahead of those with lower GPA. That is the third priority for listing. Tutors with high GPA will usually tutor well. Tutors without uploading school record and GPA will be listed behind.

When a tutor is logged on the website and ready for tutoring, ready sign will appear next to the tutor's name. Click the tutor's name icon, will get into the tutor's page. Detailed information of the tutor will be displayed, such as photo, age, school, major, grade, GPA, self description and so on. Click view icon to see and verify academic documents the tutor uploaded such as student ID, school record, photo ID and so on. When satisfied with the uploaded materials, click “start tutoring” icon to request tutoring. When the tutor clicks “agree tutoring” icon, both sides will be connected, and can see and hear each other. At that time, the learner can tell whether the tutor online is the same person as shown on the picture of tutor's student ID. And the website starts to record tutoring time. The website will also accumulate total tutoring time of each tutor.

When a tutor has been certified by the website, then no need to check the tutor's documents.

When a tutor need to write or draw, can aim with camcorder head. Both tutor and learner can terminate tutoring process by clicking end icon anytime during tutoring. A tutoring process will be stopped by the website when there is no enough money on the learner's account. When a tutoring is over, the website transfers tutor fee from the trainee's account to the tutor's account according to time of tutoring and the fee requirement set by the tutor. The website will deduct certain percentage of administration fee.

Learner can evaluate quality of a tutoring by clicking satisfied or unsatisfied icon when it is over. If a learner did not do evaluation within certain time after a tutoring is over, it will be treated as satisfied.

The website will automatically record tutoring process. Video of tutoring can be watched on the website with payment. Watching tutoring video will normally be cheaper than being tutored online. A tutor can write a name and an abstract for each video for learners to select. Tutors could also upload tutoring videos from other places for watching with payment.

A video tutoring process can be watched by third parties by clicking watch icon in the tutor page with payment cheaper than being tutored directly.

Tutoring can also be done with written messages. A learner can send a message regarding study questions to a tutor selected. The message will be saved on the website, until the tutor logs in and sees it. When the tutor answers the message, the website will pay from the tutor's account to the tutor's account, after deducting certain per cent fee.

The website will set up fees for watching tutoring video, watching a tutoring process, and returning a message, in proportion to video tutoring fee per unit time, so that the fees will be easily understood and remembered by learners and tutors. For example, set fee for watching a tutoring process to be half of the fee for video tutoring. Fee for sending a message by a learner will also be set by the website, for example $0.50 each.

During a tutoring process while a learner and a tutor are connected together online by the APP, they can exchange written messages free without charge.

No school or company is involved in registration and tutoring, tutors and learners are self-served on the website to be convenient and to save cost. Unless paid by tutors to certify their academic documents, the website will only occasionally and randomly check tutor's academic documents. The website could also automatically check student ID and photo ID.

The advantages of the tutor website are:

1. Low tutor fee. Lower tutor fee by students than by professional teaches or graduates who already have jobs; low cost to operate the website, since no school or company is involved in tutoring and registration; tutoring fees set by tutors will be low because of numerous competitions.

2. Convenient for tutors and learners to use, registration is serf-serving and very simple especially for learners, and tutoring can be done almost anytime anywhere.

3. Because of the low cost and convenience, one on one tutoring can be done on large scale, and tutoring quality will be better than large size classes.

4. Wide range of tutors can be chosen from the website because there is no limit on tutor quantity, and graduates as well as professional teachers could also register as tutors.

One on one tutoring on large scale, not only can enhance quality of education and learners' study scores, but also can enhance tutors' own education, communication, and interests on work and study. Also, large scale human resources of college and graduate students will be effectively utilized.

It can also facilitate education reform. As one on one tutoring online prevails, and study scores and learning ability improves significantly, many large size classes could be reduced.

The website is also good for employers to select talented employees. Employers can select employees by tutor's school, major, grade, diploma, GPA, and percent of learners' satisfaction. Employers could also watch tutoring video. Whereas employers' hiring on the website could also facilitate enthusiasm of tutoring.

1: method of tutoring online comprising:
means for tutor registration, wherein a college or graduate student, attending school or graduated, registers on a self-serving website with an APP down loaded in tutor registration section, by filling in real name, school, major, grade or degree, and GPA, uploading student ID or diploma, and school record;
means for searching tutors on the website by learners, according to tutor's school, major, grade and GPA;
means for listing tutor names after tutor search, where tutor names are ranked by the facts including whether tutors are logged in and ready for tutoring, whether academic documents are certified, GPA is high or low, total tutoring time is long or short, and per cent of learners' satisfaction is high or low;
means for starting a tutoring process by connecting a tutor and a learner on the website with video image;
and means for paying tutor fee wherein a tutor sets up tutoring fee per unit time on the tutor's account; a learner deposits tutor fee on the learner's account; the website records tutoring time and transfers tutor fee from the learner's account to the tutor's account when tutoring is over.

2: the method of claim 1 wherein tutor's academic documents uploaded comprising school, major, grade and GPA are to be reviewed and verified by learners.

3: the method of claim 1 wherein a tutoring process is by exchanging written messages with the APP between a learner and a tutor with payment in a proportion set by the website to video tutoring fee per unit time.

4: the method of claim 1 wherein the website will automatically record tutoring process. Recorded video of tutoring can be viewed on the website with payment in a proportion set by the website to video tutoring fee per unit time.

5: the method of claim 1 wherein a video tutoring process can be watched by third parties by clicking watch icon in the tutor page with payment in a proportion set by the website to video tutoring fee per unit time.

6: method of tutoring online comprising:
means for tutor registration, wherein a college or graduate student, attending school or graduated, registers on a self-serving website with an APP down loaded in tutor registration section, by filling in real name, school, major, grade or degree, and GPA, uploading student ID or diploma, and school record;
means for searching tutors on the website by learners, according to tutor's school, major, grade and GPA;
means for starting a tutoring process by connecting a tutor and a learner on the website with video image;
and means for paying tutor fee wherein a tutor sets up tutoring fee per unit time on the tutor's account; a learner deposits tutor fee on the learner's account; the website records tutoring time and transfers tutor fee from the learner's account to the tutor's account when tutoring is over.

7: the method of claim 6 wherein method of tutoring online comprising means for listing tutor names after tutor search, where tutor names are ranked by the facts including whether tutors are logged in and ready for tutoring, whether academic documents are certified, GPA is high or low, total tutoring time is long or short, and per cent of learners' satisfaction is high or low;

8: the method of claim 6 wherein tutor's academic documents uploaded comprising school, major, grade and GPA are to be reviewed and verified by learners.

9: the method of claim 6 wherein a tutoring process is by exchanging written messages with the APP between a learner and a tutor with payment in a proportion set by the website to video tutoring fee per unit time.

10: the method of claim 6 wherein the website will automatically record tutoring process. Recorded video of tutoring can be viewed on the website with payment in a proportion set by the website to video tutoring fee per unit time.

11: the method of claim 6 wherein a video tutoring process can be watched by third parties by clicking watch icon in the tutor page with payment in a proportion set by the website to video tutoring fee per unit time.
